(19) United States
(12) Patent Application Publication
(10) Pub. No.: US 2015/0180907 A1
(43) Pub. Date: Jun. 25, 2015

(54) DETECTING CONFLICTS IN A POLICY-BASED MANAGEMENT SYSTEM

(71) Applicant: VMware, Inc., Palo Alto, CA (US)

(72) Inventors: Piyush Bharat MASRANI, Bangalore (IN); Akhil Sadashiv HINGANE, Bangalore (IN); Kumar GAURAV, Bangalore (IN); Hemant TUMBARE, Bangalore (IN)

(73) Assignee: VMWARE, INC., Palo Alto, CA (US)

(21) Appl. No.: 14/138,494

(22) Filed: Dec. 23, 2013

(51) Int. Cl. H04L 29/06

(52) U.S. Cl. CPC H04L 63/205

(57) ABSTRACT

A computing environment includes a plurality of objects that are managed according to a plurality of policies, where each policy defines an action to be performed and a condition for performing the action. When a request to create a new policy is received, a condition of the new policy is compared with conditions of existing policies that are maintained in a policy storage unit in order to determine a policy conflict. If no policy conflict is determined, the new policy is stored in the policy storage unit. An error is issued if a policy conflict is determined.

### BACKGROUND

The rapid growth of information technology has led to the establishment of large-scale data centers. Automation has become a priority among those who manage such data centers. The management of data centers through a policy-based management paradigm is one solution that has gained prominence. In typical policy-based management frameworks, administrators use a policy management system to define various conditions, which, upon their occurrence, trigger any of a number of actions. Oftentimes, the action that is taken occurs automatically, without user intervention.

A problem with existing policy-based management systems is that these systems permit the creation of potentially conflicting policies. That is, one policy may result in the triggering of an action that directly contradicts an action that is triggered by a second policy. This problem arises when the conditions giving rise to the contradictory actions may occur simultaneously. For example, a policy may be defined for virtual machines to be powered on if those virtual machines satisfy a first condition, while another policy may be defined for virtual machines to be powered off if those virtual machines satisfy a second condition. If a virtual machine is configured in such a way as to satisfy both conditions (and hence becomes subject to both policies) a conflict arises, whereby the policy management system does not have the ability to decide which of the conflicting actions to take. In a large-scale data center, with millions of managed objects, such as virtual machines, networks, datastores, and the like, the aforementioned problem is exacerbated. Hence, a policy-based management system that avoids such conflicts is desirable.

### SUMMARY OF THE DISCLOSURE

One or more embodiments provide a method for detecting policy conflicts in a plurality of policies that are used to manage a plurality of objects in a computing environment, where each policy defines an action to be performed and a condition for performing the action. The method includes the steps of receiving a request to create a new policy and comparing the condition of the new policy with conditions of existing policies that are maintained in a policy storage unit in order to determine a policy conflict. The method further includes the step of storing the new policy in the policy storage unit if no policy conflict is determined, and issuing an error if a policy conflict is determined.

Further embodiments include a non-transitory computer-readable storage medium comprising instructions that cause a computer system to carry out the above method as well as a computer system configured to carry out the above method.

### BRIEF DESCRIPTION OF THE DRAWINGS

FIG. 1 depicts a block diagram of a management server configured to detect policy conflicts, and that accesses a data center, according to embodiments.

FIG. 2A is a block diagram that depicts the assignment of one or more tags by a tagging module to one or more managed objects, according to embodiments.

FIG. 2B is a block diagram that depicts an embodiment of a tag.

FIG. 3 is a block diagram that illustrates a policy module accessing a policies table, and applying a policy stored therein to a managed object, according to one or more embodiments.

FIG. 4 depicts the static detection of two conflicting policies, according to embodiments.

FIG. 5 is a flow diagram that depicts a method performed by a policy module for detecting policy conflicts statically, according to embodiments.

### DETAILED DESCRIPTION

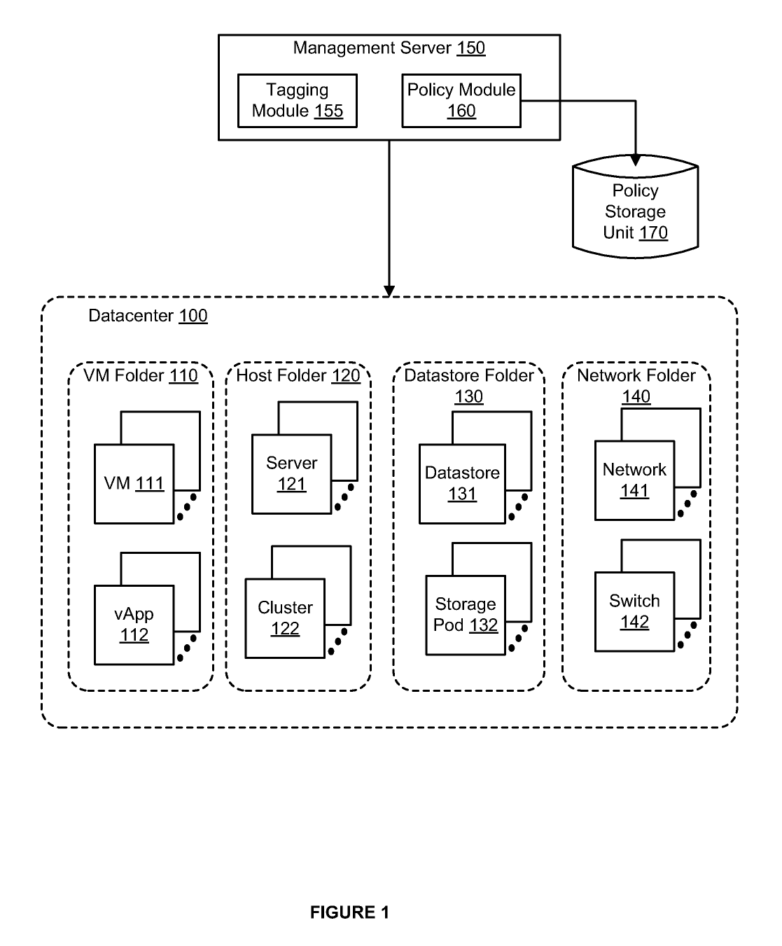

FIG. 1 depicts a block diagram of a management server 150 that is configured to detect policy conflicts among a plurality of policies, where the policies are used to manage a plurality of objects in datacenter 100, according to embodiments. As shown, management server 150 accesses a policy data storage 170, which stores the plurality of policies used to manage the datacenter objects. In addition, management server 150 accesses data center 100 that includes a plurality of managed objects. Management server 150 organizes the managed objects into folders each of a different type. In the embodiment illustrated, the managed objects of data center 100 are components of a virtualized computing environment, e.g., virtual machine objects organized into VM folder 110, host server objects organized into host folder 120, data store objects organized into datastore folder 130, and network objects organized into network folder 140. It should be noted that, in other embodiments, the managed objects of data center 100 may be organized into other folders.

As shown, VM folder 110 contains one or more virtual machines (VMs) 111. Further, VM folder 110 may also contain or more virtual applications (or “vApps”) 112. In embodiments, each of the VMs 111 or vApps 112 executes on a virtualized host computer under the control of a hypervisor.

Referring again to FIG. 1, host folder 120 comprises one or more servers 121 or clusters 122. In embodiments, servers 121 are computer hosts on which VMs 111 and vApps 112 execute. In addition, clusters 122 typically comprise a plurality of hosts 121, each of which is connected in what is often referred to as a “cluster.” Clusters are useful for distributing workload among several hosts connected in the cluster, or provide for redundant computing capacity in the event that a cluster hosts fails. In such a case, VMs that execute on the failed host may be restarted or continued on another host within the cluster.

Datastore folder 130 contains one or more datastores 131 or storage pods 132. In embodiments, datastores 131 may include physical disks that are connected to one or more host computers, as well as storage arrays that comprise several disks connected in a storage area network (SAN). In addition, datastores 131 include logical devices, such as logical unit numbers, or “LUNs,” which, in embodiments, are logical storage units that are accessed as contiguously allocated physical devices by server software. In such a case, storage management software that controls a storage array may expose the storage array's physical storage space as contiguous data segments, thus freeing application software from needing to take on the task of managing disk storage. Storage pods 132 aggregate the storage resources of associated datastore objects into a single storage resource for use by virtual machines.

FIG. 1 also depicts network folder 140, which, in the embodiment shown, contains one or more networks 141 and switches 142. A network 141 may be a local area network over which one or more locally situated hosts communicate, or it may be a high-bandwidth wide-area network that forms a communication backbone for a wide range of computer servers. In embodiments, one or more servers 121 connect to one or more networks 141 in network folder 140.

Embodiments of management server 150 include a tagging module 155 and a policy module 160 that accesses policy storage unit 170. Tagging module 155 manages the creation, updating, and deletion of tags, which, as described below, are name-value pairs that represent metadata (or properties) of a managed object. Tagging module 155 also manages the allocation (or assignment) of tags to each of a plurality of managed objects.

Policy module 160 manages the policies that are stored in policy storage unit 170. As will be described more fully below, a policy comprises a condition and an action. That is, the policy defines an action that is taken should the corresponding condition come into being. In embodiments, policy module 160 is configured to receive a request to create a new policy, and to compare the condition of the new policy requested with the conditions of the policies stored in policy storage unit 170 in order to determine whether the condition of the new policy conflicts with the conditions of the policies stored in policy storage unit 170. If policy module 160 determines that there is no conflict, then policy module 170 stores the request new policy (including the new policy condition and corresponding action) to policy storage 170. If policy module 170 detects a conflict, then, in embodiments, policy module 170 does not store the new requested policy to policy storage 170, but, instead, issues an error message.

Embodiments of management server 150 may run on any type of networked computer host, including, but not limited to, a server-class host, a desktop computer, or a laptop computer. Management server 150 may also run within a virtual machine, where the virtual machine in which management server 150 runs executes on a virtualized computer server under the control of a hypervisor. In one possible embodiment, the management server is defined by multiple physical or virtualized devices that are configured to implement the management functions.

To enable access to data center 100, embodiments of management server 150 connect to a computer network, over which management server 150 transmits and receives data. Examples of computer networks to which management server 150 connects include local area networks, such as Ethernet or Token Ring networks, campus-area or metropolitan-area networks, or wide-area networks, such as the Internet. Further, management server 150 may be connected to a wireless network, such a cellular data network. Additionally, embodiments of management server 150 may communicate using any of a number of commonly used networking protocols, such as, but not limited to, TCP/IP, IEEE 802.2, SDLC, or Bluetooth.

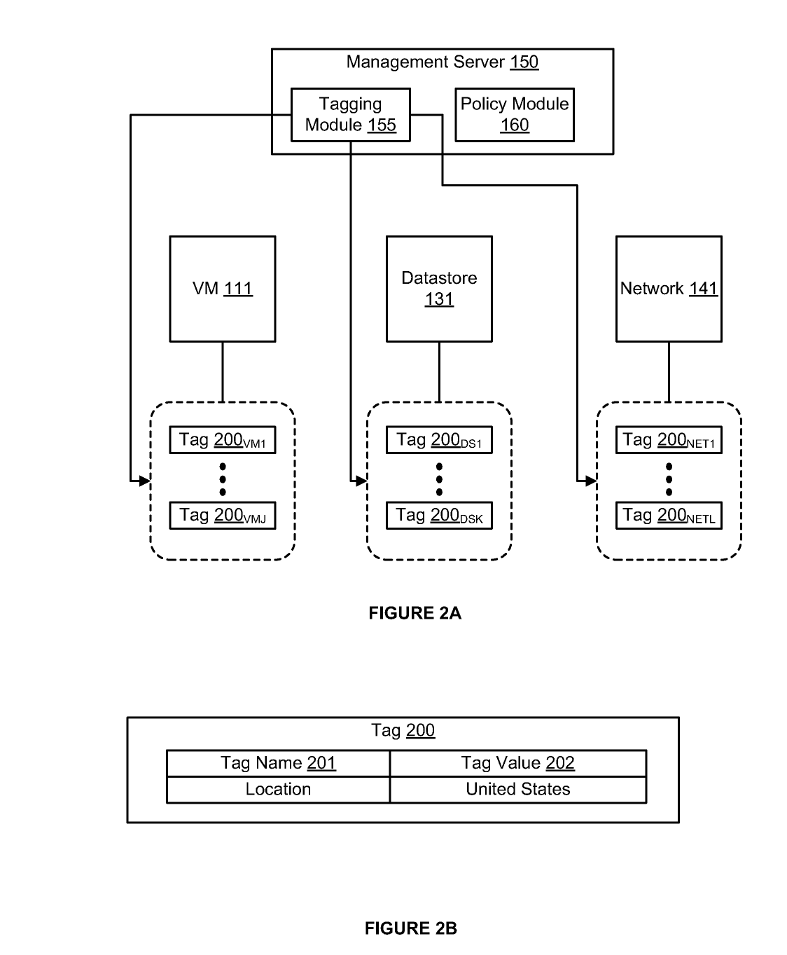

FIG. 2A is a block diagram that depicts the assignment of one or more tags by a tagging module to one or more managed objects, according to embodiments. As shown in FIG. 2, tagging module 155 is a component of management server 150. As mentioned previously, tagging module 155 manages the creation, updating, and deletion of tags, as well as the assignment of tags to managed objects. The assignment of tags to a managed object is sometimes referred to as “tagging” the managed object. In FIG. 2A, tagging module 155 creates and assigns tags 200_{VM1}-200_{VMJ} to managed object VM 111, which is a virtual machine. For example, one of tags 200_{VM1}-200_{VMJ} assigned to VM 111 may specify the location of the VM, and may be referred to as the name/value pair “Location=California.” In another example, one of tags 200_{VM1}-200_{vMJ} may be referred to as “Power On Status=ON,” which would indicate that the VM that has been tagged as such is in the “powered on” state. It is noted that, while any tag may be assigned to a VM (because tags are name/value pairs), the assigned tag usually relates to some VM property or function. Further, the same principle holds true for other tagged managed objects (such as datastores, hosts, and networks).

Continuing with FIG. 2A, tagging module 155 assigns tags 200_{DS1}-200_{DSK} to datastore 131. In embodiments, tags 200_{DS1}-200_{DSK} may indicate a type of datastore. For example, tag 200_{DS1} may be of the form “Datastore Type=Optical Disk.” In other embodiments, one of tags 200_{DS1}-200_{DSK} may indicate whether datastore 131 is a shared or local datastore. Hence, tag 200_{DS1} may be of the form “Shared Datastore=No,” indicating that datastore 131 is not shared among multiple host computers.

FIG. 2A further illustrates tagging module 155 assigning tags 200_{NET1}-200_{NETL} to network 141. Tags 200_{NET1}-200_{NETL} may indicate the transport medium underlying network 141 (e.g., optical fiber, twisted pair, or wireless). In such a case, one of tags 200_{NET1}-200_{NETL} may be of the form “TransportMedium=Wireless.”

As shown in FIG. 2A, the assignment of tags 200 to each of the managed objects creates an association between each assigned tag and the managed object to which the tag has been assigned. In embodiments, the association between a tag and the managed object to which it relates may be implemented in a relational database, a text file, or a memory-resident data structure. In addition, as depicted in FIG. 2A, a number of tags that are assigned to a managed object may be grouped together in a dataset. For example, each set of tags 200_{VM1}-200_{VMJ}, tags 200_{DS1}-200_{DSK}, and tags 200_{NET1}-200_{NETL} are shown in FIG. 2 as grouped together in a set. Further, it should be recognized that any means of relating a tag to a managed object, or grouping tags together, is within the scope of the present invention.

FIG. 2B is a block diagram that depicts one embodiment of a tag. As previously mentioned, a tag is metadata for a managed object, and is represented as a name/value pair. For example, as shown in FIG. 2B, tag 200 is comprised of tag name 201 and tag value 202. In the example depicted, tag name 201 has the value “Location,” and tag value 202 has the value “United States.” Tag name 201 can also be considered a “tag category,” which is a set or grouping of related tags. That is, tags 200 that have a common tag name 201 are considered to comprise a tag category. Thus, the tag depicted in FIG. 2B has a tag name 201 “Location” and a tag value 202 “United States.” However, another tag 200 (not depicted) may also have a tag name 201 “Location,” while having a tag value 202 “Canada.” While the tags themselves are different, the tags belong to the same category because they each have the same tag name 201 (i.e., “Location”).

It should also be noted that tag 200, as shown in FIG. 2B, may be represented using any computer-related structure that provides for relating a name to a value. While tag 200 is depicted in tabular format, it should be recognized that any data structure capable of storing a tag name 201 and a tag value 202 are contemplated and within the scope of the present invention.

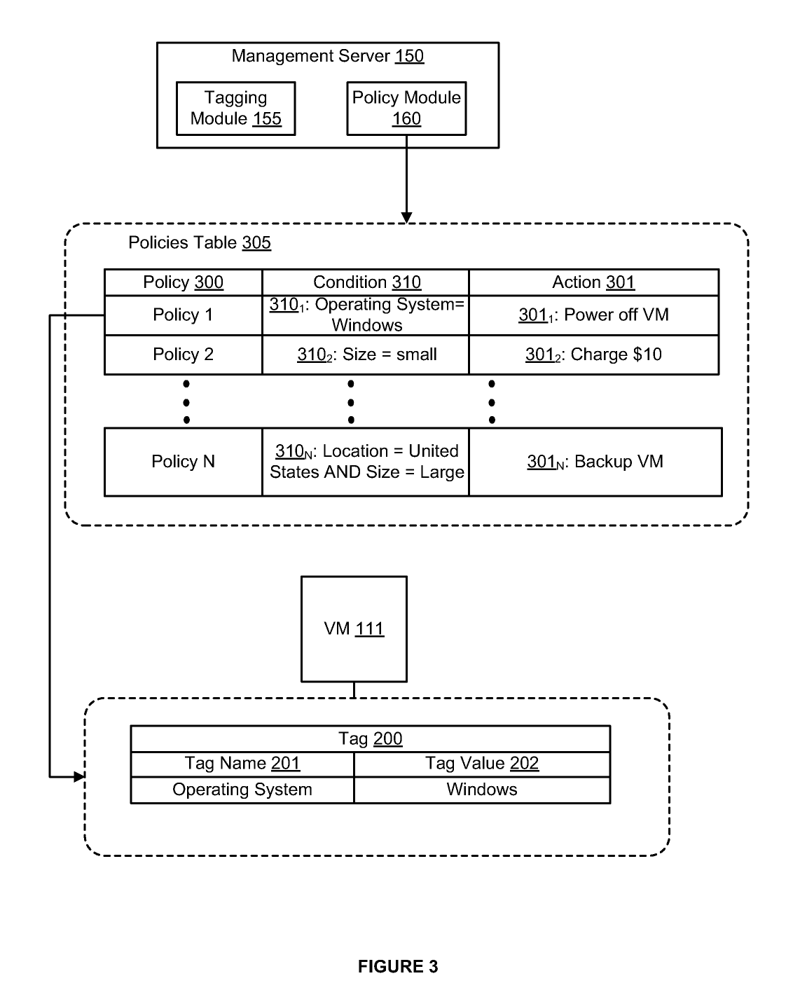

FIG. 3 is a block diagram that illustrates a policy module 160 that accesses a policies table 305, according to one or more embodiments. As shown, policy module 160 is a component of management server 150. Policy module 160 is configured to create, update, and delete policies stored in policies table 305. According to embodiments, policies table 305 is stored in policy storage unit 170 and stores policies 300 (which comprise conditions 310 and actions 301), which are applied to managed objects of the data center. Policy module 160 also determines whether a given condition is true with respect to a managed object, and, upon so determining, performs an associated action on, or with respect to, the managed object.

At a basic level, a policy comprises a condition 310 and an action 301. In embodiments, conditions 301 comprise logical expressions containing terms, each of which corresponds to a name/value pair. A policy condition is “applied” to a managed object by comparing the terms of the policy condition with the tags assigned to the managed object. As stated earlier, tags are also name/value pairs. For example, as shown in FIG. 3, policy condition 310₁ is specified as “Operating System=Windows.” In this case, policy condition 310₁ (“Operating System=Windows”) is determined to be “true” for any managed objects that are assigned a tag having this name/value pair. Thus, referring to FIG. 3, policy condition 310₁ is determined to be “true” for VM 111 because, as shown, VM 111 is assigned tag 200 comprising tag name 201 “Operating System” and tag value 202 “Windows.”

As previously mentioned, a policy also includes an action 301. In embodiments, the action associated with a policy is performed whenever it is determined that the condition associated with the policy is true with respect to one or more managed objects. As depicted in FIG. 3, policy 1 has the condition “Operating System=Windows” and an associated action of “Power Off VM.” In this case, VM 111 is assigned tag 200 having associated tag name 201 “Operating System” and associated tag value 202 is “Windows.” Thus, condition 310₁ “Operating System=Windows” of Policy 1 is true for VM 111. Accordingly, associated action “Power Off VM” is performed with respect to VM 111. That is, because VM 111 satisfies the condition 310₁ “Operating System=Windows,” policy module 160 powers off VM 111. Moreover, the power off operation would be performed on any managed object assigned the tag “Operating System=Windows.”

It should be noted that FIG. 3 represents one embodiment of a policies table (or storage). Policies table 305 may be embodied in a relational database, a hierarchical database, in Extended Markup Language (XML) files, or in any other structure or structures capable of storing policies 300, conditions 310, and actions 301.

As depicted in FIG. 3, policy module 160 stores multiple policies in policies table 305. As such, two or more policies may be in conflict with each other. Embodiments of policy module 160 are configured to detect a conflict between policies. First, embodiments of policy module 160 determine whether each policy has an action that is in conflict with the action of the other policies. For example, a policy 300₁ may include condition 310₁ and action 301₁, where action 301₁ is “Power on VM.” Further, policy 300₂ may include condition 310₂ and action 301₂, where action 301₂ is “Power off VM.” In embodiments, policy module 160 determines that the actions of policies 300₁ and 300₂ conflict because the actions directly contradict each other. That is, if VM 111 is tagged in a way such that the VM satisfies both conditions 310₁ and 310₂, then a policy conflict arises due to the fact that one policy (policy 300₁) directs VM 111 to be powered on, while the other policy (policy 300₂) directs VM 111 to be powered off.

Once policy module 160 determines that the actions of two policies conflict with each other, then policy module 160 determines whether the two policies have an overlap in the conditions associated with each policy. That is, policy module 160 determines that the two policies conflict when the actions of each policy conflict and when each policy has a condition that shares one or more terms with the condition of the other policy. For example, if policy 1 has condition “location=United States” OR “backup=NO” and policy 2 has condition “location=United States” OR “PowerOff=Never”, then, assuming that policy 1 and policy 2 have conflicting actions, policy module 160 determines that policy 1 and policy 2 conflict because each has a condition that includes the term “location=United States.”

It should be recognized that policy conflicts may be detected either statically or dynamically. Static detection of policy conflicts is performed at the time a policy is created by policy module 160. By contrast, dynamic detection of policy conflicts is performed at the time a policy is applied to a managed object (i.e., at “run time”), rather than at the time a policy is created.

It should be noted that detection of all policy conflicts may be deferred to run time detection. That is, even policy conflicts that may be detected statically (i.e., at the time a policy is created) may be detected at run time, when two or more conflicting policies are applied to a managed object. However, deferring all conflict detection to run time is disadvantageous because, when a conflict is encountered at run time, policy module 160 may not have enough information on how to proceed. An arbitrary decision may be made with respect to the action that should be taken, which is inefficient.

On the other hand, detecting all policy conflicts statically may also be inefficient. Indeed, two policies may appear to be in conflict, yet such a conflict is unlikely to occur in a production environment. For example, an administrator creates a policy 1 that has a condition “country=India” and an action “backup VM at 2 AM EST.” Thus, any VM that has a tag “country=India” will be backed up at 2 AM Eastern Standard Time. An administrator may also create a policy 2 that has a condition “state=New York” and action “backup VM at 3 AM EST.” Thus, any VM that has a tag “state=New York” will be backed up at 3 AM Eastern Standard Time. If a particular VM is tagged with each of the tags from policy 1 and policy 2, then there is a conflict because the actions are contradictory. However, this is a conflict that is unlikely to occur because tagging a VM with both “country=India” and “state=New York” is a mistaken configuration of the VM. Statically detecting conflicts in anticipation of such erroneous configurations will result in detecting conflicts that are unlikely to occur, which results in unnecessary overhead. Thus, two policies are determined to be statically in conflict when there is an overlap in their conditions. Potential conflicts between policies that have contradictory actions, but non-overlapping conditions, are detected at run time.

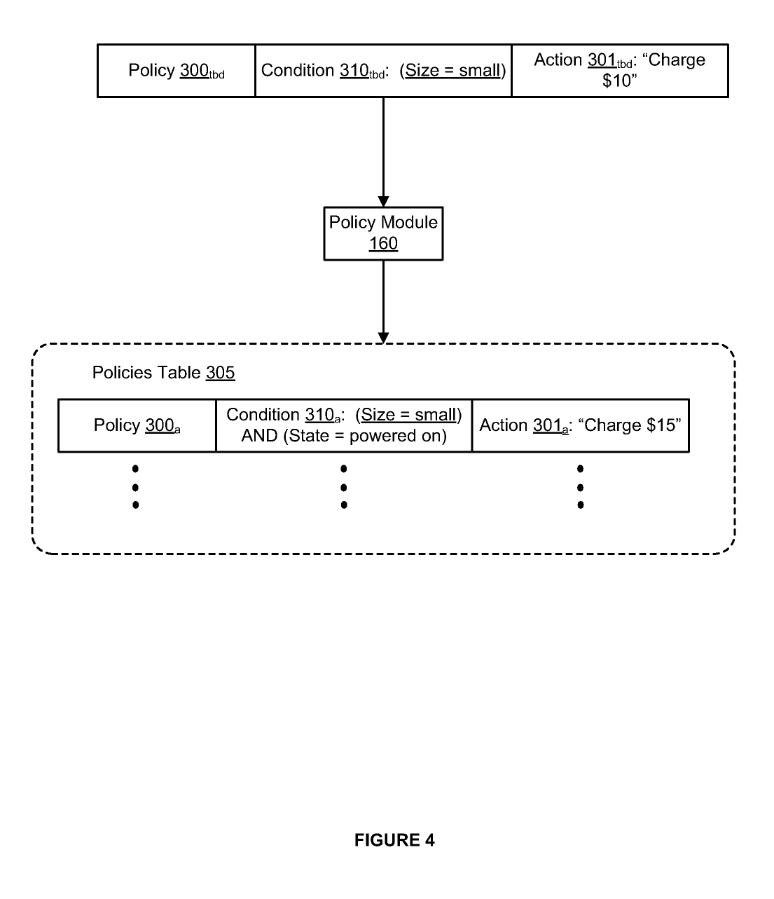

FIG. 4 depicts static detection of two conflicting policies, where the conflict arises because the policies have overlapping conditions. That is, the policy conflict is detected with respect to a policy to be created, depicted as policy 300_{tbd}, and an existing policy, depicted as policy 300ₐ. As shown, policies table 305 stores policy 300ₐ, which has condition 310ₐ, “Size=small” AND “State=powered on.” Further policy 300ₐ includes action 301ₐ, “charge $15.” Policy 300_{tbd}, which an end user or system administrator requests to be created, includes condition 310_{tbd}, “Size=small”, and action 301_{tbd}, “charge $10.”

As shown, condition 310_{tbd} of policy 300_{tbd} includes a term that overlaps with a term of condition 300ₐ of policy 300ₐ (i.e., “Size=small”). Thus, policy module 160 detects this conflict at the time policy 300_{tbd} is requested to be created. In one or more embodiments, policy module 160 scans policies table 305 for all policies that include the same condition (or sub-condition) that is specified for any policy 300_{tbd} that is requested to be created. If a conflict is detected, policy module 160, in some embodiments, disallows the creation of policy 300_{tbd}. In other embodiments, policy module 160 issues a warning to a system administrator.

In embodiments, policies with complex conditions may be defined. In such cases, in order to statically determine whether two policies with complex conditions conflict, it is advantageous to simplify the two policies to the greatest extent possible so that conflicts among policies may be detected correctly. That is, if policies are not simplified, there is a chance that two or more policies may be mistakenly determined to be in conflict. As an example, a first policy 300₁ has a condition 310₁ “size=small.” Further, policy 300₁ includes action 301₁ “charge $20.” A second policy 300₂ has an associated condition 310₂ “location=India” OR ((“size=small”) AND (location=“India”)). Additionally, policy 300₂ includes action 301₂ “charge $10.” Although both policies 300₁ and 300₂ include the sub-condition “size=small”, it should be noted that these two policies do not conflict. Upon closer inspection of policy 300₂, it can be shown that condition 310₂ may be reduced to the expression “location=India.” To see this, the sub-condition “size=small” may be represented as a logical variable A. Thus, if sub-condition “size=small” is true, then A=1. Further, sub-condition “location=India” may be referred to as logical variable B. Therefore, the complex expression “location=India” OR ((“size=small”) AND (location=“India”)) may be rewritten as the Boolean expression A+AB. Using Boolean algebra, this expression reduces to A. Hence, the condition associated with policy 300₂ reduces to “location=India”, which is not in conflict with the condition “size=small” associated with policy 300₁.

In addition, for ease of exposition, expressions within policy conditions are represented by logical variables (or “literals”). For example, the expression “size=small” is referred to above as logical variable A. Operators AND, OR, and NOT are applied to literals in order to form complex conditions. Further, expressions that share a common tag name (or tag category), but have different tag values, are represented by the same logical variable name with different subscript values. For example, if three expressions are defined as “Size=small,” “Size=medium,” and “Size=large,” then each expression is represented as A₁, A₂, and A₃, respectively.

In one or more embodiments, the process of detecting policy conflicts statically relies on certain assumptions. First, the tags are compared with policy conditions using either the “equal to” or “not equal to” operation (i.e. “=” or “≠”). Next, policy conditions are formed into complex expressions using AND, OR, or NOT operators. Further, in embodiments, determining whether a managed object is tagged in a way such that the managed object is affected by a policy assumes that certain axioms hold true. First, a managed object is either tagged according to a certain tag category, or it is not tagged with that tag category. This may be expressed by a Boolean equation: A+A′=1. Next, a managed object is tagged according to a tag category if the object is assigned any tag value from the tag category. That is, A₁+A₂+=A. Additionally, a managed object is assigned a tag category if the object is assigned a specific tag value from the category, or if the converse of that tag value is assigned to the object. That is, tag category A is assigned to a managed object if either a specific tag Aᵢ or a converse tag Aᵢ′ (i.e., any other tag that is not Aᵢ) is assigned to the managed object.

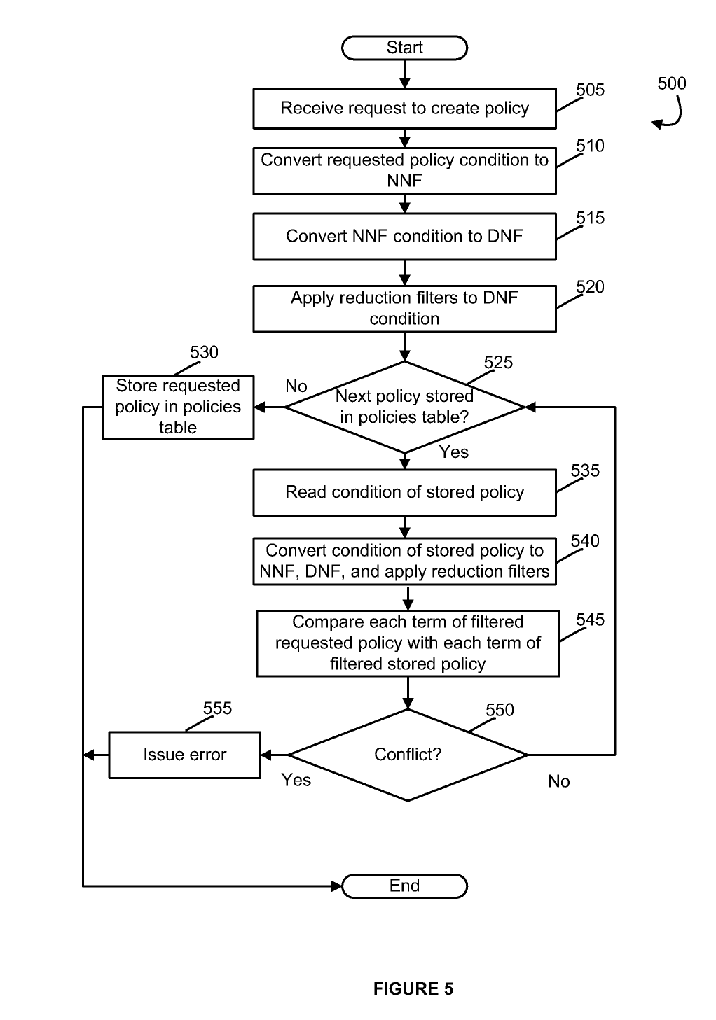

FIG. 5 is a flow diagram that depicts a method 500 performed by policy module 160 for detecting policy conflicts statically (that is, at the time a new policy is to be created), according to embodiments of the present invention. Method 500 begins at step 505, where policy module 160 receives a request to create a new policy 300 for data center 100. The request received at step 505, in embodiments, includes the policy to be created. That is, the request includes a condition 310 and action 301 that correspond to the new policy.

At steps 510-520, embodiments of policy module 160 perform steps to simplify condition 310. As previously mentioned, it is advantageous to simplify a policy condition to the greatest extent possible so that the policy may be compared to other policies in order to detect conflicts. Embodiments of policy module 160 perform reduction and filtrations steps in order to convert a complex policy condition to an equivalent condition that facilitates efficient conflict detection.

At step 510, policy module 160 converts policy condition 310 to a “negation normal form”, or “NNF.” In embodiments, conversion to negation normal form entails representing a complex policy condition in a logically equivalent fashion by distributing NOT operators to the individual literals by applying DeMorgan's law and eliminating any double negations. The resulting condition only contains AND, OR, and NOT operators, where all NOT operators apply to individual literals.

An example that illustrates step 510 follows. Assume that policy condition 310 (which is associated with policy 300 that is requested to be created) comprises the expression (AB)′, where A corresponds to a first expression (e.g., “location=United States”), while B corresponds to a second expression (e.g., “size=small”). Policy condition 310 is thus satisfied by any managed object that does not have both tags “location=United States” and “size=small” assigned to it. Converting this condition to NNF entails distributing the NOT operator to the individual literals, according to DeMorgan's law. Thus, condition (AB)′ becomes the equivalent NNF condition A′+B′, according to DeMorgan's law. This NNF condition is satisfied by any managed object that does not have either tag “location=United States” or “size=small” assigned to it. As can be seen, the two conditions are equivalent.

At step 515, an NNF policy condition produced at step 510 is converted into a “disjunctive normal form,” or DNF. DNF is a representation of a complex expression as a disjunction of conjunctive clauses. It should be recognized that disjunctive terms are separated by OR (+) operators, while conjunctive terms are separated by AND operators. Examples of expressions that are in a DNF are A, A+B, AB, and AB+CD.

As example that illustrates step 515 follows. Assume a complex condition 310 is specified as A+(B+C)(B′C′). In this case, A corresponds to a first expression, “location=United States,” B corresponds to a second expression, “size=small,” and C corresponds to a third expression, “state=powered on.” Note that the term A is in DNF form. In order to fully convert condition 310 to DNF form, the second term (B+C)(B′C′) is multiplied through according to the rules of Boolean algebra. After doing so, the second term is expanded to read: BB′C′+CC′B. Hence the condition 310 in DNF form reads: A+BB′C′+CC′B′.

At step 520, embodiments of policy module 160 apply one or more reduction filters to the DNF condition produced at step 515. For example, in one or more embodiments, a complement product filter is applied to the DNF condition produced at step 520. A complement product filter eliminates terms of a DNF complex condition where a literal and its complement are present together. For example, in the example set forth above, the DNF condition produced at step 515 is A+BB′C′+CC′B′. Applying a reduction filter to this condition results in the terms BB′C′ and CC′B′ being removed (or filtered) from the condition. This is due to the fact that the filtered terms resolve to 0 (or false), because BB′ and CC′ must be false under the rules of Boolean algebra. Hence, the complex DNF condition A+BB′C′+CC′B′ reduces to the simple DNF expression A. That is, any managed object that is tagged with tag name “location” and tag value “United States” satisfies condition 310.

A second type of filter that, in embodiments, policy module 160 applies at step 520 is a distributive law filter. This filter checks to see whether any term in the DNF condition produced at step 515 contains a term that is a subset of one or more other terms in the DNF condition. If such a term exists, then policy module 160 applies a distributive law filter to eliminate all terms that contain the subset term (i.e., policy module 160 eliminates all “superset” terms). For example, assume that step 515 produces a DNF condition A+AB. Here, policy module 160 determines that A is a subset of the term AB. Hence, policy module 160 applies a distributive law filter to the DNF condition A+AB, which results in the simple DNF condition A.

A third filter that policy module 160 applies at step 520 is referred to as a product exclusion filter. In this case, if two literals (i.e, simple expressions) in a single term of a complex DNF condition are of the same tag category (i.e., both have the same tag name), but have different tag values, then embodiments of policy module 160 apply a filter to eliminate such terms from the complex DNF condition. For example, assume that the DNF expression A₁A₂+B is produced at step 515. A₁ corresponds to the tag category “location” and the tag value “United States,” while A₂ corresponds to the tag category “location” and the tag value “Canada.” Literal B corresponds to the tag category “size,” which means that sub-condition B is true for any managed object that has a tag with tag name of “size” assigned to it. In this case, policy module 160 eliminates the term A₁A₂ from the DNF condition because the term A₁A₂ sets a condition that can only be true for objects that are assigned two tags of the same tag category that have different values, which tagging module 155 does not allow.

A fourth filter that policy module 160 applies at step 520 is referred to as a redundancy product filter. Assume that a tag category A is comprised of three specific tags A₁, A₂, and A₃. Assume a condition A₁A₂′, where A₂′ is equivalent to the expression A₁+A₃+A′. That is, the condition A₂′ is equivalent to the condition that either tag A₁ or A₃ is assigned to a managed object, but not tag A₂. Alternatively, none of the tags from tag category A may be assigned to a managed object (this condition represented as A′). In this case, embodiments of policy module 160 are configured to convert condition A₁A₂′ into its equivalent expression, namely A₁(A₁+A₃+A′). Applying distributive laws, this expression is converted to A₁A₁+A₁A₃+A₁A′. A redundancy product filter applied by policy module 160 then converts the condition A₁A₁ to A₁. Further, A₁A₃ and A₁A′ are reduced to 0 (since the conditions A₁A₃ and A₁A′ must be false). Thus, policy module 160 converts the expression A₁A₂′ to A₁, which is an NNF expression in DNF form.

After one or more filters are applied at step 520, method 500 proceeds to step 525. At step 525, policy module 160 determines whether a next policy that has an action that is in conflict with the action of the policy to be created is stored in policies table 305. If a next policy having a conflicting action is stored in policies table 305, then policy module 160, at step 535, reads a condition 310 that corresponds to the determined next policy. At step 540, policy module 160 performs steps equivalent to steps 510, 515, and 520 with respect to the condition read at step 525. That is, policy module 160, at step 525, converts condition 310 corresponding to the stored policy read from the policies table to an NNF form, converts the NNF condition, to a DNF condition, and applies filters to the DNF condition. Hence, after step 540, the policy condition received at step 505 and the policy condition read at step 535 are simplified for comparison.

At step 545, policy module 160 compares the filtered DNF policy condition produced at step 520 to the filtered DNF policy condition produced at step 540 in order to detect a conflict between the two policies. It should be noted that the filtered DNF policy condition produced at step 520 corresponds to the policy condition received at step 505 and the filtered DNF policy condition produced at step 540 corresponds to the policy condition read at step 535.

As mentioned previously, two policy conditions conflict when either of the two conditions, in reduced DNF form, has a term that is a subset of any term in the other policy, which is also in DNF form. A subset term may be either a literal (or simple expression), or a complex expression that, in a DNF condition, is a conjunction of literals. Thus, if the filtered DNF condition produced at step 520 is AB+CD, and the filtered DNF condition produced at step 540 is AB+EF, then policy module 160 determines that the two policies conflict. At step 545, policy module compares the policies term by term in order to find a conflict.

At step 550, policy module 160 determines whether the comparison performed at step 545 results in a conflict between the two policies. If a conflict is determined at step 550, then method 500 proceeds to step 555, where an error is issued. In one or more embodiments an error condition is handled by preventing the policy received at step 505 from being defined and stored in policies table 305. In other embodiments, an error condition is communicated to a system administrator via a user interface, where the system administrator may take appropriate action. After step 555, method 500 terminates.

If, at step 550, policy module 160 determines that no conflict between the two policy conditions exist, method 500 returns to step 525 to determine whether a next policy is stored in policies table 305. Method 500 then proceeds with steps 535-550 for further policies that are stored in policies table 305.

If, at step 525, policy module 160 determines that there are no next policies stored in policies table 305, then policy module 160, by that point, has failed to locate a policy that conflicts with the policy to be added. Hence, method 160 then proceeds to step 530, where policy module 160 stores the policy received at step 505 in policies table 305. After step 530, method 500 terminates.

Although one or more embodiments have been described herein in some detail for clarity of understanding, it should be recognized that certain changes and modifications may be made without departing from the spirit of the disclosure. The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, yielding, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. In a computing environment that includes a plurality of objects that are managed according to a plurality of policies, each of which defines an action to be performed and a condition for performing the action, a method for detecting policy conflicts, the method comprising:
receiving a request to create a new policy;
comparing a condition of the new policy with conditions of existing policies that are maintained in a policy storage unit to determine a policy conflict; and
storing the new policy in the policy storage unit if no policy conflict is determined and issuing an error if a policy conflict is determined.

2. The method of claim 1, further comprising:
determining that the condition of the new policy is not in a first format; and
in response to the determination, transforming the condition of the new policy into the first format.

3. The method of claim 2, wherein the step of transforming the condition of the new policy into the first format comprises transforming the condition of the new policy into a negation normal format (NNF).

4. The method of claim 3, wherein the step of transforming the condition of the new policy into the first format further comprises transforming the condition of the new policy into a disjunctive normal format (DNF).

5. The method of claim 4, further comprising applying one or more reduction filters to the transformed condition of the new policy.

6. The method of claim 5, further comprising:
determining that the condition of one or more of the existing policies is not in the first format; and
in response to the determining regarding the existing policies, transforming the conditions of said one or more of the existing policies into the first format.

7. The method of claim 1, wherein the conditions of the new and existing policies each comprises a plurality of terms and the step of comparing the condition of the new policy with the conditions of existing policies comprises:
comparing each term of the condition of the new policy with each term of the conditions of the existing policies.

8. The method of claim 1, wherein the plurality of managed objects includes one or more virtual machines.

9. The method of claim 1, wherein the policy storage unit comprises one or more extended markup language (XML) files.

10. A non-transitory computer readable storage medium having stored thereon computer readable program code for detecting policy conflicts among a plurality of policies that are used to manage a plurality of objects in a computing environment, wherein each policy defines an action to be performed and a condition for performing the action, the computer readable program code comprising:
instructions to receive a request to create a new policy;
instructions to compare a condition of the new policy with conditions of existing policies that are maintained in a policy storage unit to determine a policy conflict; and
instructions to store the new policy in the policy storage unit if no policy conflict is determined and instructions to issue an error if a policy conflict is determined.

11. The computer readable storage medium of claim 10, the computer readable program code further comprising:
instructions to determine that the condition of the new policy is not in a first format; and
in response to the determining, instructions to transform the condition of the new policy into the first format.

12. The computer readable storage medium of claim 11, wherein the instructions to transform the condition of the new policy into the first format comprise instructions to transform the condition of the new policy into a negation normal format (NNF).

13. The computer readable storage medium of claim 12, wherein the instructions to transform the condition of the new policy into the first format further comprise instructions to transform the condition of the new policy into a disjunctive normal format (DNF).

14. The computer readable storage medium of claim 13, the computer readable program code further comprising instructions to apply one or more reduction filters to the transformed condition of the new policy.

15. The computer readable storage medium of claim 14, the computer readable program code further comprising:
instructions to determine that the condition of one or more of the existing policies is not in the first format; and
in response to the determining regarding the existing policies, instructions to transform the conditions of said one or more of the existing policies into the first format.

16. The computer readable storage medium of claim 10, wherein the instructions to compare the condition of the new policy with the conditions of existing policies comprise:
wherein the conditions of the new and existing policies each comprises a plurality of terms, instructions to compare each term of the condition of the new policy with each term of the conditions of the existing policies.

17. The computer readable storage medium of claim 10, wherein the plurality of managed objects includes one or more virtual machines.

18. The computer readable storage medium of claim 10, wherein the policy storage unit comprises one or more extended markup language (XML) files.

19. A computing system configured to detect conflicts among a plurality of policies, comprising:
a plurality of objects;
storage storing a plurality of policies used to manage the plurality of objects; and
a management server configured to:
receive a request to create a new policy;
compare a condition of the new policy with conditions of existing policies that are maintained in the storage to determine a policy conflict; and
store the new policy in the storage if no policy conflict is determined and issue an error if a policy conflict is determined.

20. The computing system of claim 19, wherein the management server is further configured to:
determine that the condition of the new policy is not in a first format; and
in response to the determining, transform the condition of the new policy into the first format.
